(19) United States
(12) Patent Application Publication
(10) Pub. No.: US 2003/0029338 A1
(43) Pub. Date: Feb. 13, 2003

(54) Printing machine for printing sheets and strips

(76) Inventor: Ebe Hesterman, Badhoevedorp (NL)

Correspondence Address: Jordan & Hamburg, 122 East 42nd Street, New York, NY, 10168, US

(21) Appl. No.: 09/890,508

(22) PCT Filed: Dec. 1, 2000
(86) PCT No.: PCT/EP00/12125

(30) Foreign Application Priority Data
Dec. 3, 1999 (DE) 299 21 185.1

(51) Int. Cl. B41F 5/16; B41F 7/02

(52) U.S. Cl. 101/183; 101/217

(57) ABSTRACT

A printing machine, especially a rotary offset printing machine, has a counter-pressure cylinder (2), to which at least one printing group (S, S′), which is assigned between a feed system (3) and a delivery system (4) in the direction of rotation (D) thereof. The plate and/or rubber blanket cylinders (5, 6) of the printing group (S, S′) and/or perfecting printing group are constructed as a cassette-shaped modular unit (C, C′), which can be shifted from a use position axially into a servicing position.

This invention relates to a printing machine, especially a rotary offset printing machine for printing sheets and strips according to the introductory portion of claim 1.

With known satellite printing machines (DE 43 03 796 A 1), the number of rubber and plate cylinder pairs around a printing cylinder is limited to four for reasons of accessibility to the printing groups. With a printing facility of DE 197 50 885 C 1 also, only a closely limited operating space is available due to printing groups, which can be lifted and moved radially. Moreover, the motion of the entire printing group has a disadvantageous effect on stability. To provide access, the printing groups of U.S. Pat. No. 3,041,966, are hinged, the entire system also being costly in terms of design because of the supply assemblies, which are moved as well.

The invention relates to the problem of creating a satellite printing machine for printing sheets which, even with a close succession of its printing groups for multiple, for example, five-fold first printing, ensures good accessibility to the printing groups and is operable with short setup and service times.

Pursuant to the invention, this is accomplished by means of a printing machine with the distinguishing features of claim 1. Other major distinguishing features are given in claims 2 to 20.

Because the plate and/or rubber blanket cylinders of the inventive machine are constructed in each case as cassette-shaped constructional units, said units can be moved axially from their operating position into a servicing position. In spite of the close succession of the printing groups, this makes possible a simple method for adapting quickly to changed printing conditions, for example, new printing plates, changed illustrations, new rubber blankets, or the like, in which good accessibility facilitates the work to be carried out. Adjustments or illustrating processes at the displaced cassette units can be performed in the servicing position, even while the production process is running. Furthermore, a plurality, especially five, of inking rollers can be allocated to each plate cylinder of the cassette units, which otherwise would adversely affect access to the plate cylinder and the rubber blanket cylinder. Moreover, optimum printing quality can be ensured. Above all, even with satellite printing machines, a printing process with four colors and one decorative color in one gripper bite is possible with the inventive system.

For satellite printing machines, advantageously only a single central counter-pressure cylinder is provided, to which at least four satellite printing groups for first printings can be assigned in the direction of rotation between the feed cylinder and the output cylinder. Moreover, at least one additional satellite printing group can be provided for a perfecting printing behind, in the direction of rotation, the delivery system and in front of the feed cylinder. This type of machine configuration advantageously comprises a central rubber blanket cylinder as a counter-pressure cylinder, so that it thus is possible to produce a multi-colored first printing and at least one single-colored perfecting printing with the sheet or web-like printing stock. Said material can be printed without additional transfer or turning technology during a single run without intermediate drying.

The various cassette units can be connected at a low cost by a control computer, so that optionally the plate cylinder or the rubber blanket cylinder are moved from their operating position into the servicing position, in which especially a dust-free servicing zone is provided for illustrations and in said zone an automatic and flawless illustrating process is performed.

The modular cassette units advantageously are usable in rotary offset machines, in which the plate cylinder and/or the rubber blanket cylinder and/or the counter-pressure cylinder is/are moveable in the axial direction. Likewise, provisions are made so that completely moveable perfecting printing groups can be integrated with the system as cassette units. This overall concept of the design makes optimum accessibility to the drive or the operating side of the machine possible. While retaining stability, both satellite printing machines can be provided with four printing groups, in which no prevention of accessibility has been noted. On the other hand, the system is so flexible, that alternately a manual or an automatic plate change or an automatic illustrating process can be carried out.

Further details and advantageous effects of the invention arise out of the following description and drawings, which illustrate an example of the inventive satellite printing machine. In the drawing:

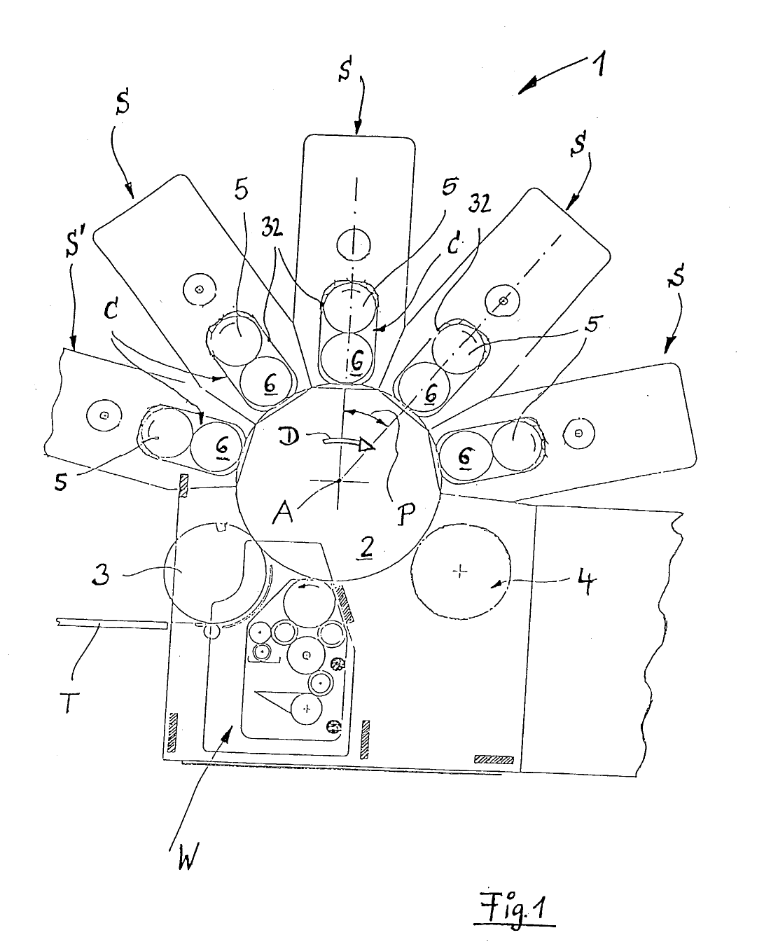

FIG. 1 shows a side elevation of the printing machine designed as satellite printing machine, with a perfecting unit and with satellite printing groups distributed over the periphery;

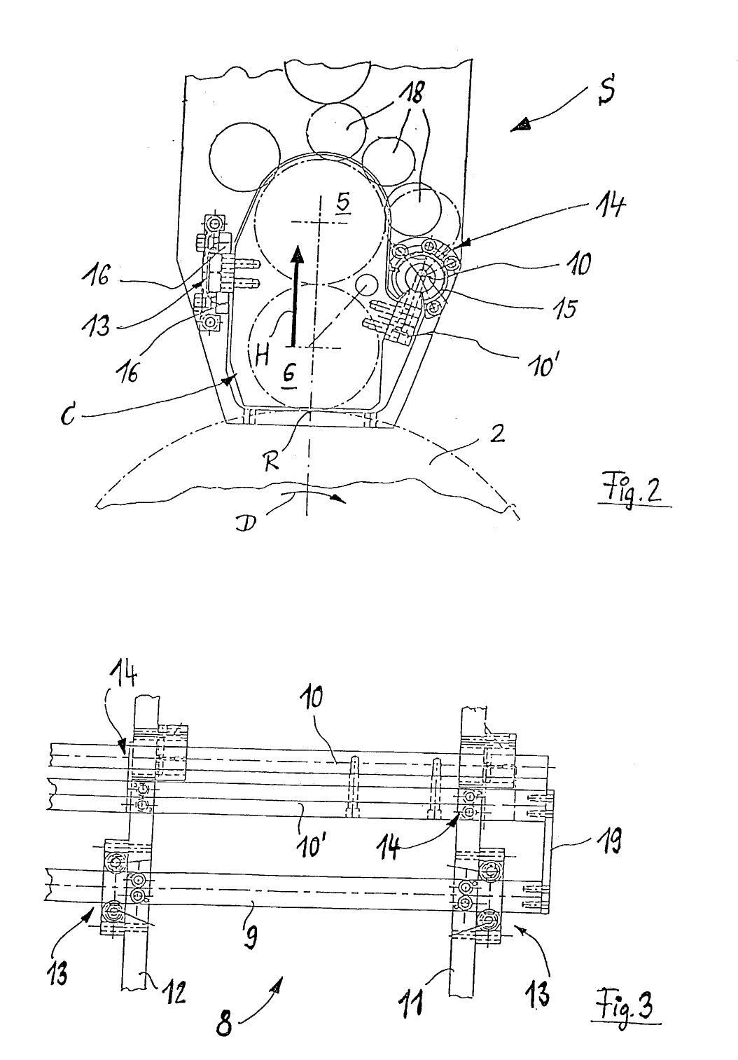

FIG. 2 shows an enlarged sectional view of a printing group provided with a cassette unit in an operating position at the central counter-pressure cylinder;

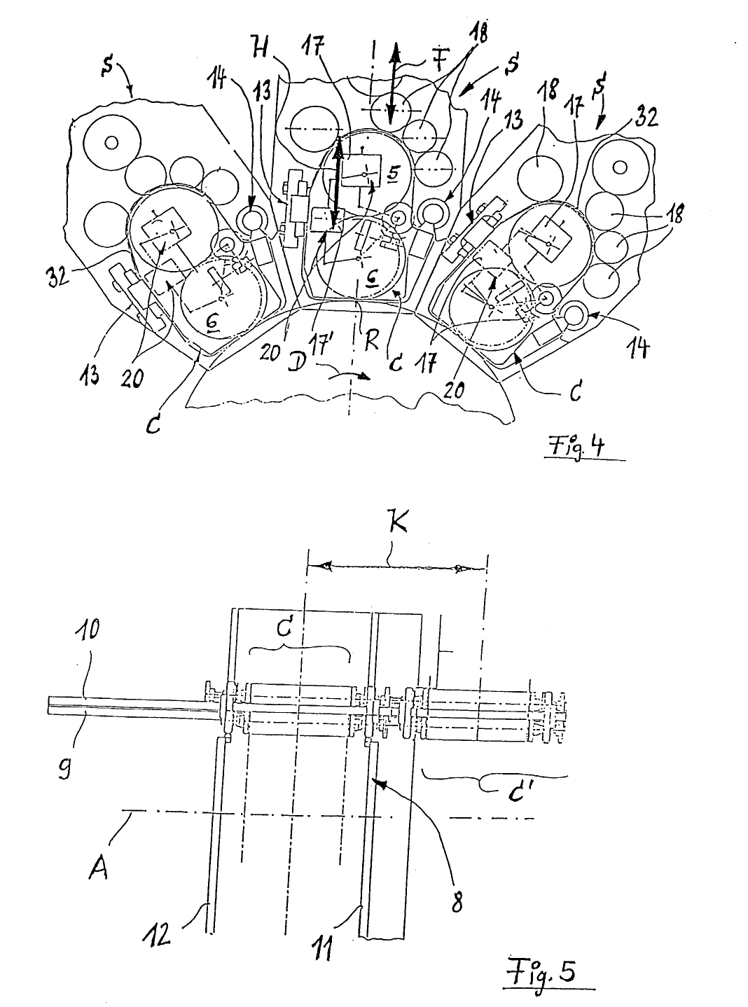

FIG. 3 shows a plan view of a machine frame with components for the axial displacement of the cassette unit;

FIG. 4 shows a diagrammatic representation similar to FIG. 2, with a plurality of cassette units in the operating position;

FIG. 5 shows a sectional view of the machine in the area of a satellite printing group with a cassette unit, which is shown in the operating position and after having been displaced laterally;

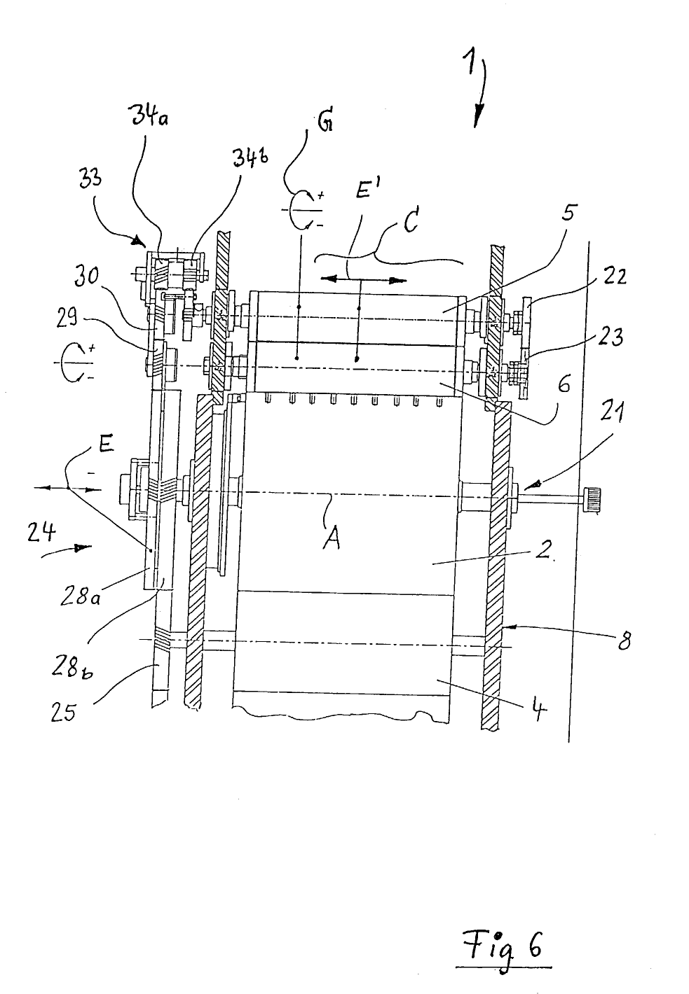

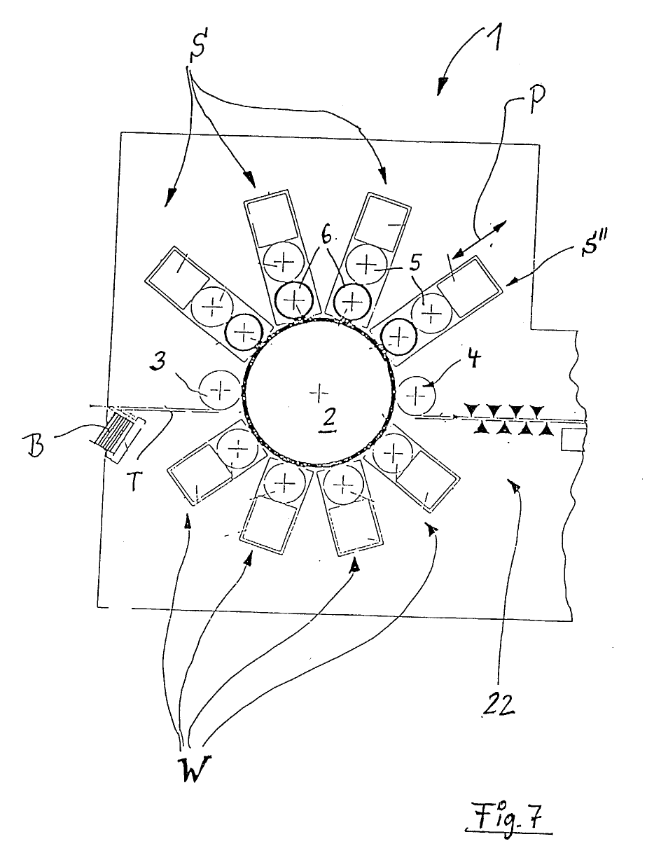

FIG. 6 shows an enlarged horizontal view of a satellite printing machine in the area of the central counter-pressure cylinder and its drive components,

FIG. 7 shows a diagrammatic representation of a satellite printing machine with cassette units in the area of the four first printing mechanisms and four perfecting units groups,

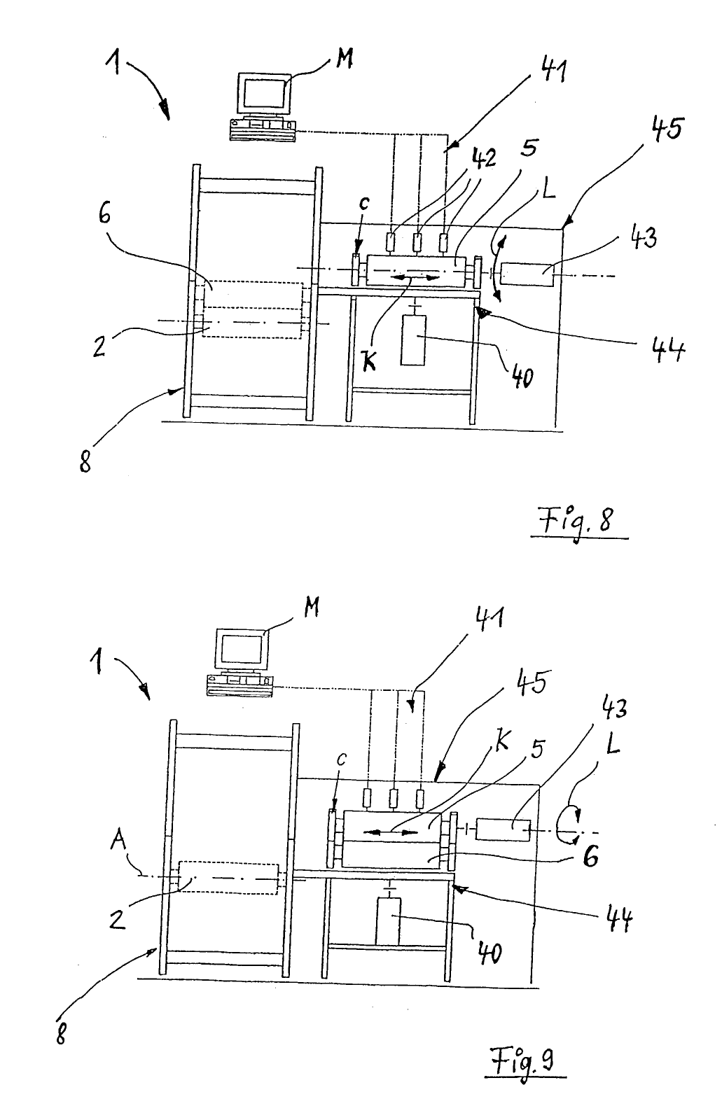

FIG. 8 shows a diagrammatic representation of a three-cylinder printing machine with the plate cylinder moved into the servicing position,

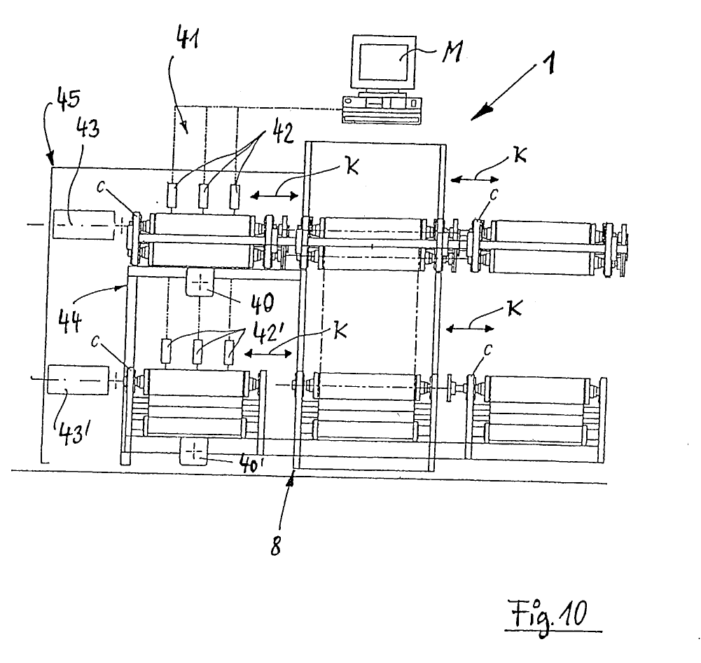

FIG. 9 shows a diagrammatic representation similar to FIG. 8 with the cassette unit comprising the plate and rubber blanket cylinder, which is in the servicing position; and

FIG. 10 shows a diagrammatic representation of cassette units for first and perfecting printing in servicing positions, which are provided on both sides of the machine frame at a satellite printing machine.

FIG. 1 shows a printing machine, which is labeled 1 as a whole, and a printing machine constructed as a satellite printing machine and having a single central counter-pressure cylinder 2, to which more than four satellite printing groups S, S′, namely five in the embodiment shown, are assigned in the direction of rotation D between the feed cylinder 3, which forms part of a feed system, and, for example, a delivery system 4 comprising, for example, a delivery cylinder.

The satellite printing machine 1, is provided especially with a counter-pressure cylinder 2, which is constructed as a rubber cylinder. To the latter, at least one additional satellite printing group W for at least single-color perfecting printing is assigned and, in the direction of rotation D, is behind the delivery system 4 and in front of the feed cylinder 3 (FIG. 1). FIG. 7 shows a plurality of satellite printing groups W for perfecting printing. When sheets are processed as printing stock, the feed cylinder 3 and the delivery system 4 are provided as gripper units or vacuum cylinders, the details of which are not shown. Furthermore, an aligning table T is arranged before the feed cylinder 3, which can be adjusted in the transverse direction, in height and/or transversely to the direction of feed while the printing machine is being operated.

In the inventive design, the satellite printing groups S comprising a plate cylinder 5 and a rubber sheet cylinder 6, are structured in each case as a cassette-shaped modular unit C. After their rubber cylinder 6, which lies in contact with the counter-pressure cylinder 2 in the printing position (FIG. 2), is raised, the cassette units C can be moved axially into an operating and servicing position, without having to tilt or raise the cassette units C. This sliding construction increases the positional stability of the cassette units C, so that, during the printing a low-vibration printing process is possible, which eliminates distortions.

The individual representation of one of the cassette units C of FIG. 5 illustrates their position in a machine frame, which is labeled 8 as a whole, the cassette unit C being illustrated in the center section of the representation within the machine frame 8, and the right side of the picture showing that the cassette unit, which now is labeled C′, can be moved into a lateral servicing position in the axial direction adjacent to the machine frame 8, for example on the operating side of the latter (arrow K, FIG. 5). Thus the entire cassette unit C′ is positioned adjacent to the machine frame 8 or the counter-pressure cylinder 2. It is also conceivable that the cassette unit C is shifted only partly or in the direction of the axis of rotation A to the opposite side of the machine frame 8, so that the cassette unit C′ is located on the drive side (FIG. 10, left side).

With this inventive concept of the satellite printing machine 1, up to six indirect satellite printing groups S can be assigned to the counter-pressure cylinder 2 for first printing, and up to six direct satellite printing groups W for indirect perfecting printing. In a compact construction, they may be placed directly adjacent to each other. In a preferred embodiment, the counter-pressure cylinder 2 comprises a circumference of 500 to 3000 mm and the five satellite printing groups S for first printing may be disposed in the area of the upper arc of the counter-pressure cylinder 2, so that a central angular distance P of 35° to 45° and preferably of 38° is formed between the center planes of the satellite printing groups S (FIG. 1).

The one printing group W for perfecting printing is assigned to the above-described configuration of the satellite printing groups S in this peripheral area of the counter-pressure cylinder 2, which is located opposite said printing groups S, so that the perfecting printing can take place in the area between the feed cylinders 3 and the satellite printing group S′, which is the next one in the peripheral direction D of the counter-pressure cylinder 2. It is likewise conceivable that the first printing and the perfecting printing take place simultaneously in the area of this satellite printing group S′.

Together, FIGS. 2, 3, and 5 illustrate the support of the respective cassette unit C, having the plate cylinder 5 and the rubber blanket cylinder 6 and provided for the shifting in the area of the machine frame. The cassette unit C is supported on the rails 9, 10 of the respective side frame 11, 12 of the machine frame 8. The cassette unit C can be moved parallel on these rails 9, 10 (arrow K, FIG. 5). Likewise, it is conceivable that the satellite printing groups S are shifted jointly with these rails 9, 10 in guides 13, 14 of the side frames 11, 12. In the embodiment shown, a linear ball bearing 15 or curved rollers 16 are provided as guides 13, 14 for the respective rails 9, 10 (FIG. 2), and the rail 10 has a traverse 10′ placed thereunder. For a positionally accurate displacement of the of the cylinders 5 and 6, the two rails 9 and 10 are connected by a supporting strut 19, so that the cassette units C can be shifted into the discharge position adjacent to the machine frame 8, shown on the right-hand side of FIG. 5, and returned in the opposite direction into the use position.

The enlarged representation of the plate and rubber blanket cylinders 5, 6 of FIG. 4 illustrate that, within their cassette housing 32, said cylinders respectively can be shifted consecutively, individually for themselves and moreover jointly, radially towards the counter-pressure cylinder 2 by driving means labeled 20 as a whole. This radial displacement makes an adjustment to the thickness of the printing stock possible during operation of the machine 1, even without moving or correcting the register.

Pneumatic cylinders 17 are conceivable as driving means 20. In a first adjusting phase, the inking rollers 18 must be lifted in a direction of the arrow F. After that the plate cylinder 5 and the rubber blanket cylinders 6 are shifted with a lifting motion (arrow H) by pneumatic cylinders 17, 17′. Subsequently, the counter-pressure cylinder 2 is free at the peripheral side at R and the cassette units C can be shifted, which is made possible owing to the fact that the drive connection of the cylinders 5, 6 is provided by gear wheels 22, 23 on the side facing the direction, in which the cassette unit C (FIG. 6) is shifted.

In FIG. 6, the assignment of the counter-pressure cylinder 2 to the plate cylinder 5 and rubber blanket cylinder 6, which are assigned in each case to a cassette unit C, is shown in plan view. On the left side of the illustration, a gear wheel connection, which passes outside the machine frame 8, is shown. The cylinders 5, 6 of the satellite printing groups S are in synchronous driving connection with the counter-pressure cylinder 2 and are can be adjusted jointly in their register position relative to the counter-pressure cylinder 2. This drive conception makes an accurate, joint register adjustment of the respective cylinders of all cassette units C possible. An adjusting means 21, which is intended for this purpose and acts on a gear wheel part 28a of a gear wheel, is shown. The associated gear wheel section 28b is immoveable and interacts with a gear wheel 25 for the driving mechanism of the delivery system 4, which correspondingly remains uninfluenced by the register adjustments. This adjustment of the cylinders 5, 6 of the cassette units C can also be made, while the satellite printing machine 1 is being operated.

The gear wheel connection 24 of FIG. 6 is provided with obliquely geared gear wheel sections 28a, 28b, 29, 30, it being possible to shift the gear wheel section 28a by means of an adjusting unit 21 in the direction of the axis A (arrow E). As a result, the gear wheels 29, 30 experience twisting. In the embodiment shown, the gear wheel 28a acts on a double gear wheel 33, the obliquely geared gear wheel section 34a of which is coupled with a straight geared gear wheel section 34b. The cassette unit C can be moved laterally (arrow E′) by means of said gear wheel section 34b, so that a peripheral register adjustment (arrow G) and a lateral adjustment can be made for the plate cylinder 5 and rubber blanket cylinder 6.

In one embodiment, the above-described printing machine 1 may be completed as a state-of-the-art rotary offset printing machine with a plurality of automated systems, so that the illustrating process of the offset plates, their semiautomatic change, washing the rubber blankets and cooling the offset plate surface are integrated in this system. By using the axially displaceable cassette unit C, C′, C″, the optimum accessibility in the area of the plate cylinder 5, the rubber blanket cylinder 6, and the counter-pressure cylinder 2 is achieved, which also offers the potential of taking up any number of perfecting printing groups W (FIG. 7).

In FIGS. 8 to 10, additional embodiments of the inventive printing machine 1 are illustrated, in which said machine is provided with a servo drive 40 for shifting the cassette units C and for carrying out additional driving functions other than the axial displacement (arrow K). In particular, additional units 41, such as illustrating devices or the like, can be provided in the displacement area of the cassette units C, so that these illustrating systems can be realized simpler in a structurally simpler fashion. Likewise, it is conceivable that one of the secondary illustrating systems can be used for several printing groups and, at the same time, the system be controlled by means of a computer M.

The cassette units C with servo motor drive 40 for the lateral movement, in combination with a precise linear guidance, make the illustrating process possible with rigidly-mounted laser heads 42 optionally are moved back and forth in a linear direction of motion solely by the cassette movement (arrow K) without using additional drive technology. A second servo motor 43 is provided for the rotary movement (arrow L). Moreover, it is conceivable that the illustrating systems in the area of the lateral servicing position are disposed so that correspondingly displaced modular units 5 or 5 and 6 (FIG. 9) are also conveniently accessible during the continuing production of the printing machine 1. Furthermore, it is conceivable that the servo drive 40 is provided not only for the main driving mechanism, but also, in addition to the illustrating process, is used for clamping the plates, fixing rubber blankets and cleaning these parts.

For shifting particularly wide and heavy cassette units C, additional guiding components 44 are provided, which support the cassette units C on the respective side (FIGS. 8 and 9: drive side, right; FIG. 9: drive side, left) of the machine frame 8 so that, for example, maximum stability and, with that, an optimum processing precision for the illustrating process are achieved.

Essential for the processing accuracy in the area of the additional units 41, especially the laser heads 42, is their position, uncoupled from the main drive, and their use under dust-free conditions, since displacement accuracies on a micrometer scale are to be realized during the illustrating process by the servo motors 40 and 43. For this reason, a housing-shaped cover 45 is provided on the servicing side of the machine 1, overlapping the components. An overpressure system or the like can ensure dust-free conditions in the area of the cover 45.

If the driving concept requires additional driving gear wheel, provisions are made to configure the gear wheel connection with a spring-mounted compensating gear tooth system of the gear wheels, so that said gear wheels intermesh without backlash.

Furthermore, at the printing machine 1 in close proximity of the delivery system 4, provisions are made to dispose additional units (not shown), which also are formed by a displaceable cassette unit, for the further processing the printing stock. Such additional systems may comprise a flexo system, a perforating system and/or a punching system.

The compact design of the machine concept comprising moveable cassette units C achieves an overall improved accessibility, and the number of dampening and inking rollers can be increased, while the stability of the system is maintained, so that the inventive printing machine 1 is able to perform any printing concepts, for example, wet offset and dry offset printing processes.

In the embodiment of FIGS. 8 and 9, the printing machine is constructed as a three-cylinder machine, so that the plate cylinder 5 alone can be moved as cassette unit C into the servicing position. Provisions are also made so that the plate cylinder 5 and the rubber blanket cylinder 6 can be shifted jointly (FIG. 9). FIG. 10 illustrates the corresponding joint shifting of the cylinders and the perfecting printing systems as cassette units. In this conception, which can be selected by the user of the machine 1, the drive side is relocated towards the left and the operator side to the right. The automatic operation by means of the control computer M is effected towards the covered components of the left-hand side and a manual operation is provided on the right-hand side.

The above-described concept of the cassette units, which can be shifted in the axial direction, can also be extended to pairs of printing cylinders with more than three subassemblies, so that especially the possible uses of satellite printing groups, the accessibility to which previously was limited, also are extended. Furthermore, the above-described cassette displacement can be used advantageously for pairs of printing cylinders with Y-shaped or H-shaped printing group configurations.

1. A printing machine, especially a rotary offset printing machine, with a counter-pressure cylinder (2) and at least one printing group (S, S′) or the like, which is disposed between a feed system (3) and a delivery system (4) in the direction of rotation (D) thereof, wherein the plate and/or rubber blanket cylinders (5, 6) of the printing group (S, S′) and/or perfecting printing group are constructed as a cassette-shaped modular unit (C, C′), which can be shifted from a use position axially into a servicing position.

2. The printing machine of claim 1, wherein the cassette units (C, C′) alternatively can be shifted in either direction of the axis of rotation (A) of the counter-pressure cylinder (2) into the servicing position.

3. The printing machine of claims 1 or 2, wherein the cassette unit (C, C′), after its rubber blanket cylinder (6), which always are in contact with the counter-pressure cylinder (2) in the printing position at, can be shifted axially into the servicing position.

4. The printing machine of one of the claims 1 to 3, wherein the cassette unit (C, C′) in the servicing position is located completely next to the counter-pressure cylinder (2).

5. The printing machine of one of the claims 1 to 4, wherein the cassette units (C, C′) are supported in their servicing position in a dust-free environment.

6. The printing machine of one of the claims 1 to 5, wherein said machine is constructed as a satellite printing machine, and the satellite printing groups (S, S′) in the area of their plate and/or rubber blanket cylinders (5, 6) form the cassette-shaped modular units (C, C′), which can be shifted axially into the servicing position.

7. The printing machine of claim 6, wherein the satellite printing machine has one or more perfecting printing groups (W) as a cassette-shaped modular unit or units, which can be shifted jointly with their inking and damping groups axially into the servicing position.

8. The printing machine of claims 6 or 7, wherein more than four satellite printing groups (S, S′) are provided.

9. The printing machine of one of the claims 1 to 5, wherein said machine is constructed as a three-cylinder printing machine, the plate cylinder and/or rubber blanket cylinder of which can be shifted individually or jointly as cassette units axially into the servicing position.

10. The printing machine of one of the claims 1 to 5, wherein said machine is constructed as a cylinder printing machine, having more than three cylinders, the plate cylinder and/or rubber blanket cylinder of which can be moved, individually or jointly as corresponding cassette units, axially into a servicing position.

11. The printing machine of one of the claims 1 to 6, wherein the cassette units (C, C′) of the printing groups (S′) are supported on rails (9, 10) of the corresponding side frames (11, 12) of the printing groups (S) and can be shifted on said rails (9, 10) or together therewith in guides (13, 14) of the side frames (11, 12) parallel and free from backlash.

12. The printing machine of one of the claims 1 to 11, wherein a plate cylinder (5) of the cassette units (C, C′) is seated in a cassette housing, so that it can be adjusted axially in the peripheral direction and obliquely, and adjusting means (21) are provided for make adjustments even while the printing machine is running.

13. The printing machine of one of the claims 1 to 8, wherein the plate and rubber blanket cylinders (5, 6) of the printing groups (S, S′) are adjustably supported by drive means (20) within the cassette housing, individually by themselves and/or jointly, against the counter-pressure cylinder (2).

14. The printing machine of one of the claims 1 to 13, wherein the cassette units (C, C′) have at least one servo drive (40, 43) which is provided for driving the plate cylinder and/or rubber blanket cylinder and/or counter-pressure cylinder.

15. The printing machine of claim 14, wherein additional drive functions can be performed with the servo drive (40, 43), which is provided for the axial displacement.

16. The printing machine of one of the claims 1 to 15, wherein additional units, such as illustrating devices and cleaning devices or the like (41) are provided within the range of displacement of the cassette units (C, C′).

17. The printing machine of one of the claims 1 to 16, wherein the cassette unit is formed by only one plate cylinder 5, the rotation of which (arrow L) is effected by the servo drive (43) during an illustrating process.

18. The printing machine of one of the claims 1 to 17, wherein a supporting guide assembly (44) is provided within the range of displacement of the cassette units (C, C′).

19. The printing machine of one of the claims 13 to 18, wherein the gear wheel connections, which are provided within the area of the servo drive (40, 43) between the plate cylinder (5) and the rubber blanket cylinder (6), are so supported by a spring-mounted compensating cogging system, that the gear wheels intermesh without backlash during the pressure actuation and the pressure take-off.

20. The printing machine of one of the claims 1 to 19, wherein an additional unit, which is constructed as a displaceable cassette unit for processing the printing stock further, is provided at the printing machine in close proximity to the delivery system (4).
